(19) United States
(12) Patent Application Publication
(10) Pub. No.: US 2013/0022395 A1
(43) Pub. Date: Jan. 24, 2013

(54) Coupling for Hair Mannequin Head

(71) Applicant: Missy Cowan, Monument, CO (US)

(72) Inventor: Missy Cowan, Monument, CO (US)

(21) Appl. No.: 13/184,824

(22) Filed: Jul. 18, 2011

(51) Int. Cl. F16B 17/00

(52) U.S. Cl. 403/376

(57) ABSTRACT

A coupling secures a mannequin head to a mannequin head holder. The mannequin head holder has a stem. The hair mannequin head has a neck with a base. An opening is formed in the base. The opening extends longitudinally into the neck for receiving the stem. The coupling has a neck engaging member, a retention mechanism, a stem engaging member, and a bridge. The neck engaging member has a pair of arms extends substantially parallel to one another. The retention mechanism is affixed to each arm and, together with the arms, grasps the neck of the hair mannequin head. A notch is formed in the stem engaging member. The notch defines a plane and has a longitudinal axis perpendicular to the plane. The longitudinal axis passes between the arms of the neck engaging member. The bridge fixes the relative positions of the neck engaging member and the stem engaging member.

### BACKGROUND

Hair mannequin heads are used in the beauty industry to practice hair styles and to demonstrate hair styles to clients. Often these hair mannequin heads are used with mannequin head holders. The mannequin head holders usually have a stem which stands upright, either clamped to a table or on a stand. The hair mannequin heads include a neck with an opening extending up through the base of the neck towards the head. The stem is inserted into the opening of the hair mannequin head. However, this configuration is often not stable. The head moves or falls off the stem while the hair on the mannequin head is being styled.

### DESCRIPTION OF THE DRAWINGS

FIG. 1 is an illustration showing how an embodiment of the present invention coupling is used with a hair mannequin head and a mannequin head holder.

FIG. 2 is an exploded view of FIG. 1.

FIG. 3 is an illustration showing more detail of the coupling shown in FIG. 1.

FIG. 4 is an illustration showing an alternative embodiment of the retention mechanism of the present invention coupling.

FIG. 5 is an illustration showing another alternative embodiment of the retention mechanism of the present invention coupling.

### DETAILED DESCRIPTION

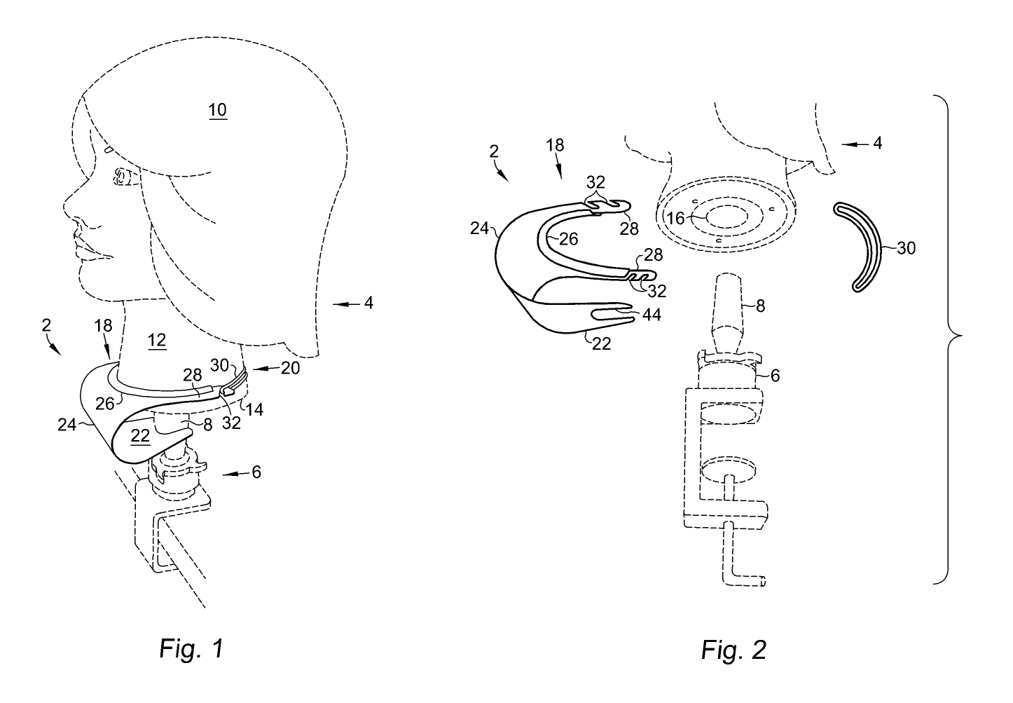

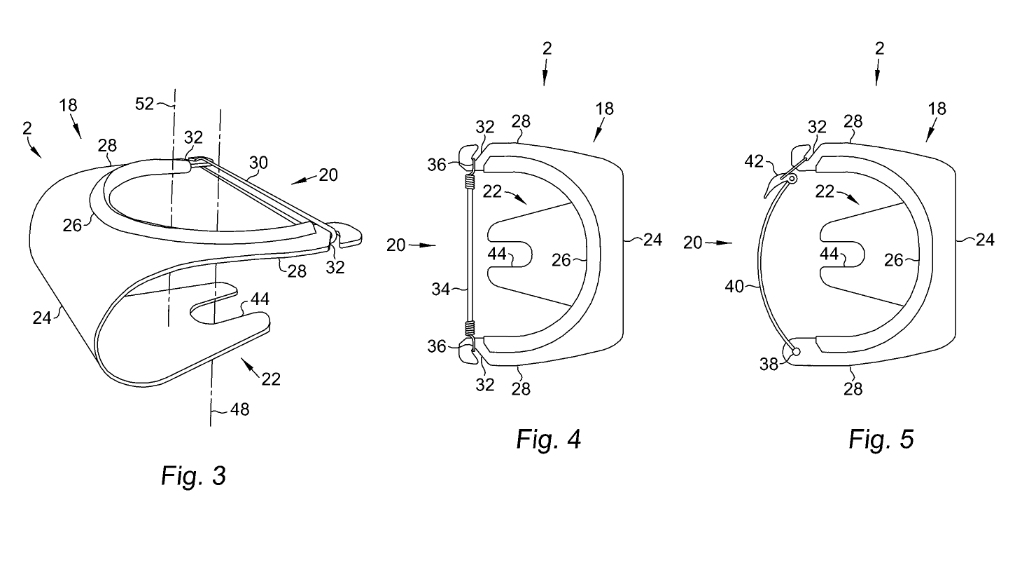

FIGS. 1 and 2 illustrate an embodiment of coupling 2 for securing hair mannequin head 4 to mannequin head holder 6. Mannequin head holder 6 has a stem 8. Hair mannequin head 4 has a head 10 and neck 12. Neck 12 has a base 14. Opening 16 is formed in base 14. Opening 16 extends longitudinally into neck 12 for receiving stem 8.

Coupling 2 has neck engaging member 18, retention mechanism 20, stem engaging member 22, and bridge 24. Neck engaging member 18 has a neck receiving abutment 26 and a pair of arms 28 extending away from abutment 26. Each arm 28 surrounds one side of neck 12 and the front of the neck abuts against abutment 26.

Retention mechanism 20 is affixed to each arm for, together with arms 28, grasping neck 12 of hair mannequin head 4 and clamping neck 12 against abutment 26. In one embodiment, retention mechanism 20 includes elastic band 30 and either one or multiple pairs of slots 32 are formed in each arm 28 for receiving band 30. In another embodiment, shown in FIG. 4, retention mechanism 20 includes elastic strap 34 having a hook 36 on each end and wherein slot 32 is formed in each arm 28 for receiving one of the hooks 36.

In an alternate embodiment, shown in FIG. 5, retention mechanism 20 includes hinge 38 carried by one of the pair of arms 28 and grasping member 40 affixed to the hinge 38. Retention mechanism 20 further includes catch 42 for affixing grasping member 40 to the arm 28 not carrying hinge 38.

Stem engaging member 22 has notch 44 formed therein. Notch 44 may have multiple segments for receiving stems 8 of multiple sizes. Notch 44 defines a plane and has longitudinal axis 48 perpendicular to the plane. Longitudinal axis 48 passes between arms 28 of neck engaging member 18. In one embodiment, abutment 26 and arms 28 define a plane having longitudinal axis 52 perpendicular to the plane. In one embodiment, longitudinal axis 52 is parallel with longitudinal axis 48 of notch 44. In one embodiment, longitudinal axis 52 and longitudinal axis 48 of notch 44 are coaxial. In one embodiment, longitudinal axis 52 is central between arms 28 and the longitudinal axis 48 is centered on notch 44.

Bridge 24 interconnects neck engaging member 18 and stem engaging member 22. Bridge 24 fixes the relative positions of neck engaging member 18 and stem engaging member 22 to one another. In one embodiment, bridge 24 is rigid.

Although coupling 2 is illustrated as having a C-shaped profile, the shape of the profile may be any shape which folds back upon itself, such that notch 44 and arms 28 are properly aligned as described. For example, the profile of coupling 2 may be a bracket shape or an open-sided square or rectangular shape.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A coupling for securing a hair mannequin head to a mannequin head holder having a stem, the hair mannequin head having a neck with a base with an opening formed therein, the opening extending longitudinally into the neck for receiving the stem, the coupling comprising:
a neck engaging member having a neck receiving abutment and a pair of arms extending away from the abutment;
a retention mechanism affixed to each arm for, together with the arms, grasping the neck of the hair mannequin head;
a stem engaging member having a notch formed therein, the notch defining a plane and having a longitudinal axis perpendicular to the plane and passing between the arms of the neck engaging member; and
a bridge between the neck engaging member and the stem engaging member, the bridge fixing the relative positions of the neck engaging member and the stem engaging member to one another.

2. The coupling of claim 1 wherein the neck receiving abutment and the pair of arms define a plane having a longitudinal axis perpendicular to the plane and the longitudinal axis of the arms is parallel with the longitudinal axis of the notch.

3. The coupling of claim 2 wherein the longitudinal axis of the arms and the longitudinal axis of the notch are coaxial.

4. The coupling of claim 3 wherein the longitudinal axis of the arms is central between the arms and the longitudinal axis of the notch is centered on the notch.

5. The coupling of claim 1 wherein the retention mechanism includes a hinge carried by one of the pair of arms and a grasping member affixed to the hinge.

6. The coupling of claim 5 wherein the retention mechanism further includes a catch for affixing the grasping member to the arm not carrying the hinge.

7. The coupling of claim 1 wherein the retention mechanism includes an elastic band and wherein a slot is formed in each arm for receiving the band.

8. The coupling of claim 1 wherein the retention mechanism includes an elastic strap having a hook on each end and wherein a slot is formed in each arm for receiving one of the hooks.

9. The coupling of claim 1 wherein the bridge is rigid.
